(19) United States
(12) Patent Application Publication
(10) Pub. No.: US 2017/0276318 A1
(43) Pub. Date: Sep. 28, 2017

(54) LED DISPOSED IN A BODY INCLUDING A SOCKET

(71) Applicant: KONINKLIJKE PHILIPS N.V., Eindhoven (NL)

(72) Inventors: Huiling Pan, Shanghai (CN); Paul Scott Martin, San Jose, CA (US); Albrecht Johannes Kraus, Shanghai (CN); Chao Ding, Shanghai (CN); Sze Kuang Lee, Bayan Lepas (MY)

(21) Appl. No.: 15/512,304

(22) PCT Filed: Sep. 15, 2015
(86) PCT No.: PCT/EP2015/071028

§ 371 Date: Mar. 17, 2017

(30) Foreign Application Priority Data
Sep. 26, 2014 (CN) PCT/CN2014/000873
Oct. 31, 2014 (EP) 14191203.0

(51) Int. Cl. F21V 3/04; F21V 7/22; F21V 29/87; F21V 29/77; F21V 3/02; F21V 23/00

(52) U.S. Cl. CPC F21V 3/0445; F21V 3/02; F21V 23/005; F21V 29/87; F21V 29/77; F21V 7/22; F21Y 2115/10

(57) ABSTRACT

A device according to embodiments of the invention includes a light emitting diode (LED) mounted on an electrically conducting substrate. A lens is disposed over the LED. A polymer body is molded over the electrically conducting substrate and in direct contact with the lens.

### FIELD OF THE INVENTION

The present invention relates to a lamp set using a solid state light source disposed in a body including a socket.

### BACKGROUND OF THE INVENTION

Semiconductor light-emitting devices including light emitting diodes (LEDs), resonant cavity light emitting diodes (RCLEDs), vertical cavity laser diodes (VCSELs), and edge emitting lasers are among the most efficient light sources currently available. Materials systems currently of interest in the manufacture of high-brightness light emitting devices capable of operation across the visible spectrum include Group III-V semiconductors, particularly binary, ternary, and quaternary alloys of gallium, aluminum, indium, and nitrogen and/or phosphorus. Typically, III-V light emitting devices are fabricated by epitaxially growing a stack of semiconductor layers of different compositions and dopant concentrations on a sapphire, silicon carbide, silicon, III-nitride, GaAs or other suitable substrate by metal-or-ganic chemical vapor deposition (MOCVD), molecular beam epitaxy (MBE), or other epitaxial techniques. The stack often includes one or more n-type layers doped with, for example, Si, formed over the substrate, one or more light emitting layers in an active region formed over the n-type layer or layers, and one or more p-type layers doped with, for example, Mg, formed over the active region. Electrical contacts are formed on the n- and p-type regions.

LEDs are increasingly being used as lighting sources in automotive applications. For example, LEDs may be used in retrofit bulbs, used to replace conventional filament bulbs.

FIG. 1 illustrates a halogen light source used in an automotive application. The halogen bulb 100 plugs in to a socket 120. The socket 120 electrically connects the bulb 100 to an electrical controller, not shown in FIG. 1. The bulb 100 includes a base 104 and a lens 102. The lens 102 is often glass, which is breakable, particularly in an environment with vibration, such as an automotive environment. One purpose of socket 120, which is often plastic, is to keep the bulb 100 in a position that protects it from vibration.

US20090175044A1 discloses an LED light module where one or more LEDs are mounted, together with further electrical components, on a circuit, all of which are encapsulated in a thermoplastic polymer material which may also form lenses over the LEDs. The encapsulation material provides for heat removal as well as mechanical interfacing to a receptacle for the light module.

### SUMMARY OF THE INVENTION

It is an object of the invention to provide one or more LED(s) attached to a conductive substrate and disposed in a molded body which includes a socket.

A device according to embodiments of the invention includes a light emitting diode (LED) mounted on an electrically conducting substrate. A lens is disposed over the LED. A body is formed over the electrically conducting substrate and in direct contact with the lens. The body includes a bulb portion and a socket portion formed in a single, integrated structure.

A method according to embodiments of the invention includes attaching a light emitting diode (LED) to an electrically conducting substrate. A body is molded over the LED and the electrically conducting substrate. The body includes a bulb portion and a socket portion formed in a single, integrated structure. A lens disposed over the LED protrudes from the body.

### BRIEF DESCRIPTION OF THE DRAWINGS

FIG. 1 illustrates a halogen bulb and a socket.

FIG. 2 illustrates an LED disposed in a molded body including a socket.

FIG. 3 illustrates an example of an LED.

FIG. 4 is a cross sectional view of the structure illustrated in FIG. 2.

FIG. 5 illustrates an LED disposed in a molded body including a socket positioned in a luminaire

FIG. 6 illustrates a method of making the structures illustrated in FIGS. 2 and 4.

FIG. 7 illustrates an LED disposed in a molded body shaped as a heat exchanger.

### DETAILED DESCRIPTION OF THE EMBODIMENTS

In a light source including LED(s), such as a retrofit bulb for an automotive application, a glass lens is not required. Accordingly, a separate socket is not required to protect the light source, for example from vibration. In embodiments of the invention, the socket portion is included in a body molded around the LED(s).

Though in the examples below the semiconductor light emitting devices are III-nitride LEDs that emit blue or UV light, semiconductor light emitting devices besides LEDs such as laser diodes, semiconductor light emitting devices made from other materials systems such as other III-V materials, III-phosphide, III-arsenide, II-VI materials, ZnO, or Si-based materials, or non-semiconductor light emitting devices may be used.

In embodiments of the invention, a lens is formed over an LED. The LED is mounted on a conductive frame or substrate, then a body is molded around the LED, the lens, and the conductive substrate. The molded body includes a socket, used to electrically connect the LED to a larger system, such as an automobile or automobile lighting system.

FIG. 2 illustrates an embodiment of the invention. An integrated bulb and socket includes a molded body 50. Though body 50 is referred to herein as a “molded body,” body 50 may be formed by any suitable technique and need not be formed by molding. Molded body 50 may be, for example, polymer. In some embodiments, molded body 50 is thermally conductive plastic, which may conduct heat away from the LED and into the air or the conductive substrate, where it can be removed from the device. A portion of a lens 42 formed over the LED protrudes from the molded body 50. One or more LEDs may be included in molded body 50. Though the lenses 42 illustrated in FIG. 2 protrude from a single region of the side of the molded body 50, one or more lenses may be arranged in any suitable orientation, and in a single or multiple locations on the molded body 50. The molded body is not limited to the shape illustrated in FIG. 2.

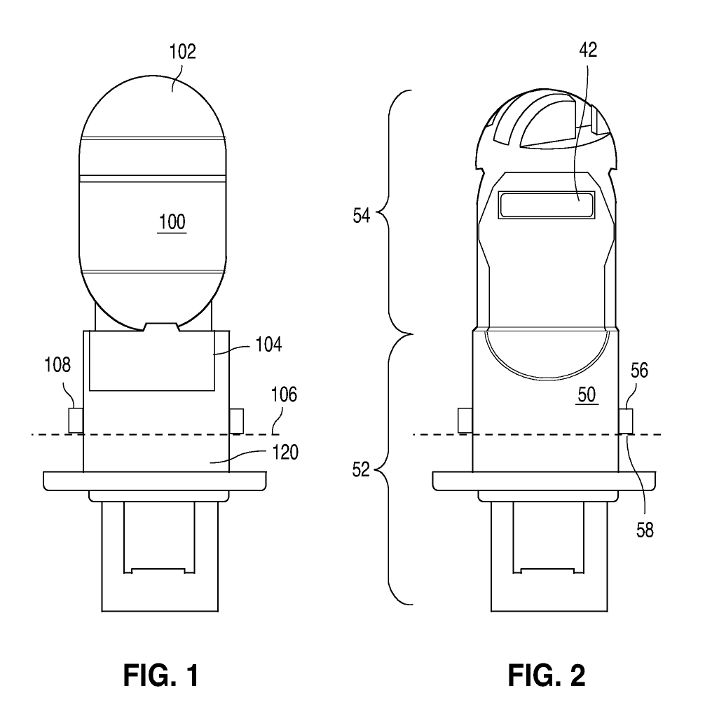

The molded body 50 includes both a bulb portion 54 and a socket portion 52, corresponding to the bulb and socket illustrated in FIG. 1. In FIG. 2, the bulb portion 54 and socket portion 52 are integrated into a single molded body 50, and are not separable like the bulb 100 and socket 120 of FIG. 1. In order to change the light of FIG. 1, the bulb 100 is removed from socket 120 and replaced. In order to change the light of FIG. 2, the entire molded body 50 including the socket portion 52 is removed and replaced; there is no separate socket.

In some applications such as automotive applications, fixtures such as the bulb and socket of FIG. 1 are often regulated by standards. For example, the bulb and socket illustrated in FIG. 1 comply with the IEC 60061 standard. The particular standard may differ and is not relevant to the invention. In order to comply with the standard, certain portions of the socket 120 and/or bulb 100 must have a particular shape. The socket 120 of FIG. 1 includes protruding portion 108, the bottom of which represents a reference line 106. Reference line 106 may be used to align the socket 120 and bulb 100 with an optic, for example, or any other structure, to insure the proper installation and optical and/or mechanical alignment of bulb 100.

In some embodiments, a molded body including a socket such as the structure of FIG. 2 complies with a standard, and therefore includes shapes, structures, and reference lines required by the standard. For example, the molded body 50 of FIG. 2 includes one or more protrusions 56, the bottoms of which correspond to a reference line for aligning the light source according to the IEC 60061 standard.

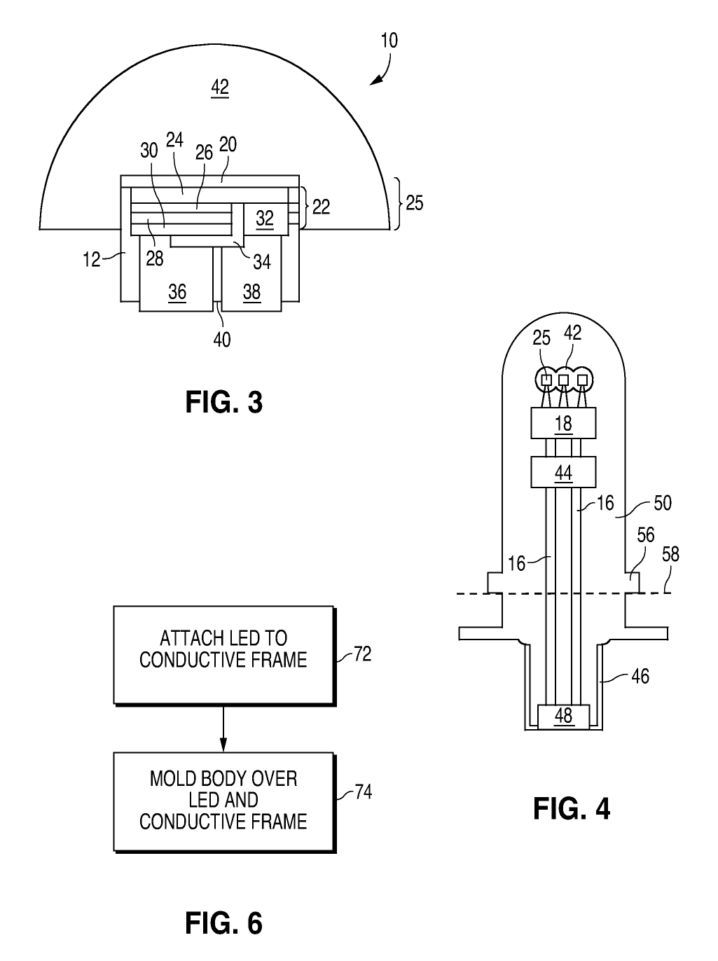

FIG. 3 illustrates one example of a suitable LED. Any suitable LED or other light emitting device may be used and the invention is not limited to the LED illustrated in FIG. 3. The device illustrated in FIG. 3 is a flip chip, meaning that one or more reflective contacts on the bottom of the LED body 25 direct light out of the top of the LED into lens 42. Other device geometries may be used; the invention is not limited to flip chip LEDs.

The LED illustrated in FIG. 3 may be formed as follows. A semiconductor structure 22 is grown on a growth substrate (not shown in FIG. 3) as is known in the art. The growth substrate is often sapphire but may be any suitable substrate such as, for example, SiC, Si, GaN, or a composite substrate. The semiconductor structure 22 includes a light emitting or active region sandwiched between n- and p-type regions. An n-type region 24 may be grown first and may include multiple layers of different compositions and dopant concentration including, for example, preparation layers such as buffer layers or nucleation layers, and/or layers designed to facilitate removal of the growth substrate, which may be n-type or not intentionally doped, and n- or even p-type device layers designed for particular optical, material, or electrical properties desirable for the light emitting region to efficiently emit light. A light emitting or active region 26 is grown over the n-type region. Examples of suitable light emitting regions include a single thick or thin light emitting layer, or a multiple quantum well light emitting region including multiple thin or thick light emitting layers separated by barrier layers. A p-type region 28 may then be grown over the light emitting region. Like the n-type region, the p-type region may include multiple layers of different composition, thickness, and dopant concentration, including layers that are not intentionally doped, or n-type layers.

After growth of the semiconductor structure, a p-contact is formed on the surface of the p-type region. The p-contact 30 often includes multiple conductive layers such as a reflective metal and a guard metal which may prevent or reduce electromigration of the reflective metal. The reflective metal is often silver but any suitable material or materials may be used. After forming the p-contact 30, a portion of the p-contact 30, the p-type region 28, and the active region 26 is removed to expose a portion of the n-type region 24 on which an n-contact 32 is formed. The n- and p-contacts 32 and 30 are electrically isolated from each other by a gap which may be filled with a dielectric 34 such as an oxide of silicon or any other suitable material. Multiple n-contact vias may be formed; the n- and p-contacts 32 and 30 are not limited to the arrangement illustrated in FIG. 3. The n- and p-contacts may be redistributed to form bond pads with a dielectric/metal stack, as is known in the art.

Thick metal pads 36 and 38 are formed on and electrically connected to the n- and p-contacts. Pad 38 is electrically connected to n-contact 32. Pad 36 is electrically connected to p-contact 30. Pads 36 and 38 are electrically isolated from each other by a gap 40, which may be filled with a dielectric material. Pad 38 is electrically isolated from the p-contact 30 by dielectric 34, which may extend over a portion of the p-contact 30. Pads 36 and 38 may be, for example, gold, copper, alloys, or any other suitable material formed by plating or any other suitable technique. Pads 36 and 38 in some embodiments are sufficiently thick to support the semiconductor structure 22 such that the growth substrate can be removed.

In some embodiments, instead of thick metal pads 36 and 38, the semiconductor structure is attached to a host substrate, which may be, for example, silicon, ceramic, metal, or any other suitable material. In some embodiments, the growth substrate remains attached to the semiconductor structure. The growth substrate may be thinned and/or textured, roughened, or patterned.

Many individual LEDs 10 are formed on a single wafer. In the regions between neighboring LEDs 10, the semiconductor structure is entirely removed by etching down to the substrate, or the semiconductor structure is etched down to an electrically insulating layer. A dielectric material 12 is disposed in the areas between LEDs 10. Material 12 may mechanically support and/or protect the sides of LEDs 10 during later processing, such as dicing. Material 12 may also be formed to prevent or reduce the amount of light from escaping from the sides of LEDs 10.

The growth substrate is then removed from a wafer of LEDs. The growth substrate may be removed by, for example, laser melting, etching, mechanical techniques such as grinding, or any other suitable technique. The semiconductor structure 22 of LEDs 10 may be thinned after removing the growth substrate, and/or the exposed top surface may be roughened, textured, or patterned, for example to improve light extraction from the LEDs 10.

In some embodiments, a wavelength converting layer 20 is connected to the surface of LEDs 10 exposed by removing the growth substrate, or to the growth substrate in devices where the growth substrate remains attached to the semiconductor structure. Wavelength converting layer 20 may be any suitable material formed by any suitable technique. Multiple wavelength converting layers may be used. The wavelength converting material may be conventional phosphors, organic phosphors, quantum dots, organic semiconductors, II-VI or III-V semiconductors, II-VI or III-V semiconductor quantum dots or nanocrystals, dyes, polymers, or other materials that luminesce. In various embodiments, wavelength converting layer 20 may be, for example, one or more powder phosphors mixed with transparent material such as silicone that is dispensed, screen printed, stenciled, or pre-formed then laminated over LED 10, or a pre-formed luminescent ceramic or phosphor dispersed in glass or other transparent material that is glued or bonded to LED 10.

The wavelength converting layer 20 absorbs light emitted by the LEDs and emits light of one or more different wavelengths. Unconverted light emitted by the LEDs is often part of the final spectrum of light extracted from the structure, though it need not be. Examples of common combinations include a blue-emitting LED combined with a yellow-emitting wavelength converting material, a blue-emitting LED combined with green- and red-emitting wavelength converting materials, a UV-emitting LED combined with blue- and yellow-emitting wavelength converting materials, and a UV-emitting LED combined with blue-, green-, and red-emitting wavelength converting materials. Wavelength converting materials emitting other colors of light may be added to tailor the spectrum of light emitted from the structure.

Non-wavelength-converting materials, for example to cause scattering or to alter the index of refraction of the layer, may be added to the wavelength converting layer 20. Examples of suitable materials include silica and TiO₂. In some embodiments, no wavelength converting material is used in the device.

Before or after forming the wavelength converting layer 20 or attaching a preformed wavelength converting layer 20 to the LED, a wafer of LEDs may be diced into individual LEDs or groups of LEDs. The LED illustrated in FIG. 3 is separated from a wafer by cutting the dielectric 12 surrounding the LED body 25.

Wavelength converting layer 20 may be formed over the LED body 25 before or after attaching the LED to a conductive substrate, as described below.

An optical element 42 is disposed over the LED. Optical element 42 is a structure that may alter the pattern of light emitted by the LED. Examples of suitable optical elements include lenses such as dome lenses and Fresnel lenses, and other structures such as optical concentrators. For economy of language, optical element 42 is referred to herein as a lens. Lens 42 may be a pre-formed lens that is glued or otherwise attached to LED body 25, or a lens that is formed over LED body 25, for example by molding. Lens 42 often extends over the sides of LED body 25 as illustrated in FIG. 3, though this is not required. In some cases one physical lens may cover more than one LED. The use of one lens over multiple LEDs may have advantages in optical performance of the system, since by placing multiple LEDs on the conducting substrate, LEDs of different color, different shape, and/or different electrical performance can be placed in proximity to each other and with specific optical coupling into a suitable, single physical lens.

A molded lens 42 may be formed as follows. A mold with an interior shaped as lens 42 is lowered over the LED body 25. The mold may optionally be lined with a non-stick film that prevents the sticking of molding material to the mold. In some embodiments, plasma such as O₂ plasma is applied to the top surface of the LED body 25, to improve the adhesion of the molding material to the LED body. The region between the mold and the LED body 25 is filled with a heat-curable liquid molding material. The molding material may be any suitable optically transparent material such as silicone, an epoxy, or a hybrid silicone/epoxy. A hybrid may be used to more closely match the coefficient of thermal expansion (CTE) of the molding material to that of the LED body 25. Silicone and epoxy have a sufficiently high index of refraction (greater than 1.4) to facilitate light extraction from the LED as well as act as a lens. One type of silicone has an index of refraction of 1.76. In some embodiments, a wavelength converting material such as phosphor is dispersed in the molding material. An optical element with dispersed wavelength converting material may be used instead of or in addition to wavelength converting layer 20. A vacuum seal may be created between the LED body 25 and the mold, and the two pieces may be pressed against each other so that the LED is inserted into the liquid molding material and the molding material is under compression. The mold may then be heated, for example to about 150° C. or other suitable temperature for a suitable time to harden the molding material into lens 42. The finished device, as illustrated in FIG. 3, is then released from the mold.

Lenses 42 may be molded over the LEDs in groups, as illustrated in FIG. 4, such that the lenses 42 of neighboring devices are connected.

Lens 42 may be formed over the LED body 25 before or after attaching the LED to a conductive substrate, as described below.

FIG. 4 is a cross section of the structure illustrated in FIG. 2.

As illustrated in FIG. 4, one or more LEDs 25 are attached to an electrically conducting substrate 18. LEDs 25 may be directly connected to substrate 18 via the pads 36 and 38 shown in FIG. 3, which may be electrically and physically attached to the substrate 18. Alternatively, LEDs 25 may be electrically connected to the substrate 18 via wires or any other suitable structure. Conductive substrate 18 may be metal, flexible polymer such as polyimide, or any other suitable material that can sustain exposure to temperatures required for polymer molding (e.g. temperatures in excess of 260° C. for more than 10 seconds). In some embodiments, conductive substrate 18 is a material with thermal conductivity of at least 100 W/mK such as, for example, C194 copper. Conductive substrate 18 may include electrically isolated members that electrically connect to the anode and cathode connections on the LED (pads 36 and 38 in the device illustrated in FIG. 3) and any other circuit elements. The conductive substrate 18 may include an external portion that protrudes from the molded body. The external portion may be used to electrically connect the conductive substrate to a power source which may supply current to the conductive substrate to forward bias the LED, such that the LED emits light.

In the structure illustrated in FIG. 4, an electrical connection structure 48, such as a plug or a receiver for a plug, is recessed in the bottom of body 50. Electrical connection structure 48 is electrically connected to substrate 18 through any suitable structure such as, for example, leads 16.

One or more optional additional circuit elements 44 may be attached to conductive substrate 18 or to leads 16 within or outside of molded body 50. Additional circuit element 44 may be a non-light-emitting circuit element. Additional circuit element 44 may be, for example, an electrostatic discharge protection circuit, power conditioning circuitry, driver circuitry, control circuitry, a leaded resistor, a leaded diode, or any other suitable circuit element. Leaded resistors and diodes are standard discrete circuit elements with leads (long wires) on both ends. These devices can be conveniently connected to the conducting substrate 18 or to leads 16 with techniques such as soldering, laser welding and resistance welding. Leaded components are used when removing the heat source, for example the resistor body, from the temperature sensitive circuit elements, for example the LEDs, is desired. The additional circuit element 44 may be totally encased within the molded body 50, or all or a portion of additional circuit element 44 may protrude from the molded body 50.

Molded body 50 may be any suitable material including, for example, plastic, polycarbonate, polyolefin, PPA, PPS, or polymer such as silicone rubber. In some embodiments, molded body 50 is a thermally conductive plastic with a thermal conductivity of at least 1 W/mK. In some embodiments, the use of a thermally conducting plastic removes the need for an additional heat-sink. In some embodiments, molded body 50 is a material such as a plastic with an electrical resistivity of at least 10,000 Ωm, in order to electrically isolate parts disposed within the molded body 50 such as leads 16.

In some embodiments, a portion of molded body 50 is painted or coated with an electrically insulating paint 46. For example, as illustrated in FIG. 4, a portion of the molded body in the vicinity of electrical connection structure 48 may be painted with electrically insulating paint, such that the thermally conducting plastic of molded body 50 is not in direct contact with the electrical connection structure 48. The electrically insulating paint allows electrically conductive plastics or polymers to be used as molded body 50. In some embodiments, conductive substrate 18 is coated or painted with electrically insulating paint in order to isolate a circuit disposed on conductive substrate 18 from an electrically-conductive molded body 50. In some embodiments, an electrically conducting molded body 50 may be used to provide an electrical shield to protect circuit elements from electromagnetic interference (EMI), and/or to reduce or eliminate electrical noise when the circuit is driven with or internally generates a non-DC electrical waveform.

In some embodiments, the body 50 is molded from an electrically conducting polymer such as graphite loaded Polycarbonate. The electrically conducting molded body 50 can itself form part of the electrical circuit for the device, thereby removing a requirement for additional separate components and potentially distributing heat into the molded body 50 or removing heat from the molded body 50.

In some embodiments, molded body 50 covers at least a portion of lens 42, such that lens 42 is embedded in body 50. Molded body 50 is in direct contact with a portion of lens 42. Molded body 50 is typically opaque, though it may be transparent or translucent in some embodiments.

In some embodiments, the molded body 50 includes fins on the exterior surface which provide direct thermal coupling to the ambient air. These fins may be designed using procedures well known in the art to create efficient heat dissipation structures.

FIG. 5 illustrates a structure including an LED disposed in a molded body including a socket, installed in a luminaire. The molded body 50 is disposed in a reflector 62 which is part of the luminaire. The lenses 42 disposed over several LEDs protrude from at least two sides of the molded body 50, as illustrated. Light 60 emitted from the LEDs and extracted from lenses 42 may reflect off reflector 62 and be redirected forward (toward the left in the orientation illustrated). The reference plane 58 of molded body 50 is aligned with the surface of reflector 62. For example, the molded body 50 may be threaded through a hole in reflector 62 until such that protrusions 56 rest on a surface of the reflector 62. In some embodiments, the shape of a portion 66 of the molded body 50 that is within reflector 62 must conform to a standard. The shape of a portion 64 of the molded body 50 that is outside reflector 62 may be flexible.

FIG. 7 illustrates one example of a molded body 50 shaped into a heat exchanger. The portion 66 that is inside the reflector 62 (or above reference plane 58) in FIG. 7 is a smaller diameter cylinder, which is stacked on a larger diameter cylinder. The larger diameter cylinder is the portion 64 of the molded body 50 that is outside the reflector 62 (below reference plane 58). The portion 64 outside the reflector may be shaped as a finned heat exchanger, as illustrated in FIG. 7, or any other suitable structure. The portion 66 that is inside the reflector may be shaped as required by a standard. The electrical connection structure 48 is illustrated on a side of portion 64.

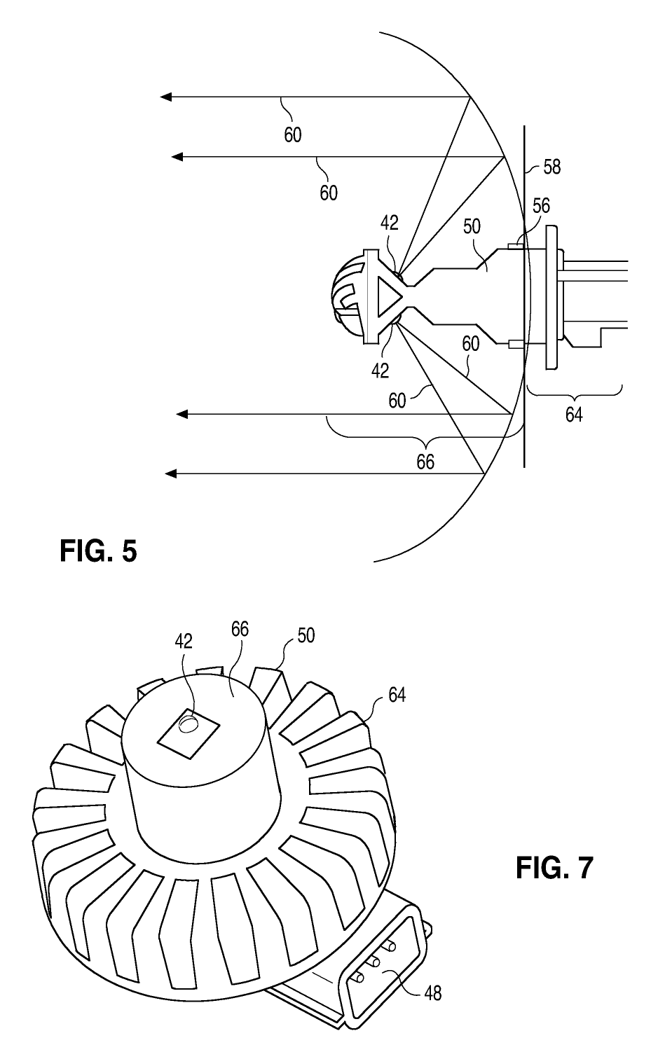

FIG. 6 illustrates a method of forming the devices illustrated in FIGS. 2 and 4. In process 72, an LED is attached to a conductive substrate. In some embodiments, the LED chip is mounted onto a conducting substrate using die attach techniques which do not fail under exposure to typical plastic molding temperatures, which may be, for example, in the range of 280-350° C. Any suitable material may be used to attach the LED to the conductive substrate such as, for example, silver die attach epoxy or eutectic AuSn solder. In addition to the LED chip, other structures which make up the electrical circuit can also be attached to the substrate in some embodiments. In some embodiments, after die attach, one or more wires are bonded to the LED and/or other circuit elements to complete electrical connection to the LED and/or other circuit elements.

In some embodiments, after process 72 the lens is molded over the LED. In some embodiments, a lens material is used that maintains at least some of its mechanical strength when subjected to plastic injection molding. Additional components such as leaded resistors, electrical wires, or packaged semiconductor devices may be attached to the conducting substrate before or after the lens is formed.

After forming the lens and attaching any non-LED electrical components, the entire assembly is placed in a plastic molding machine such as a traditional injection molding machine. Polymer is molded over the conductive substrate, optional non-LED components, and a portion of the lens in some embodiments, in process 74. In some embodiments, the polymer body forms both the mechanical body of the bulb or lamp and also the heat-sink for carrying heat from the LEDs and other electrical components to the ambient air or to leads 16.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

1. A device comprising:
a light emitting diode (LED) mounted on an electrically conducting substrate;
an optical element disposed over the LED; and
a body formed over the electrically conducting substrate and in direct contact with the optical element but covering at most a portion of the optical element, the body comprising a bulb portion and a socket portion formed in a single, integrated structure.

2. The device of claim 1 wherein the substrate is a metal frame.

3. The device of claim 1 wherein the body is opaque and covers a portion of the optical element.

4. The device of claim 1 wherein the bulb portion and the socket portion comply with a standard.

5. The device of claim 1 further comprising a reference line disposed on the body, the reference line being defined by a standard.

6. The device of claim 1 further comprising a non-light-emitting electronic component electrically connected to the LED and disposed within the body.

7. The device of claim 6 wherein the non-light-emitting electronic component is one of an electrostatic discharge protection circuit, a power conditioning circuit, a driver circuit, a control circuit, a leaded resistor, and a leaded diode.

8. The device of claim 1 wherein the body has a thermal conductivity of at least 1 Watt/meter-Kelvin.

9. The device of claim 1 wherein the electrically conducting substrate is a metal with a thermal conductivity of at least 100 Watt/meter-Kelvin.

10. The device of claim 1 wherein a portion of the body is coated with an electrically insulating coating.

11. The device of claim 1 wherein a portion of the electrically conducting substrate is coated with an electrically insulating coating.

12. A method comprising:
attaching a light emitting diode (LED) to an electrically conducting substrate;
disposing an optical element over the LED; and
molding a body over the LED and the electrically conducting substrate such that the body directly contacts the optical element but covers at most a portion of the optical element;
wherein the body comprises a bulb portion and a socket portion formed in a single, integrated structure.

13. The method of claim 12 wherein the optical element protrudes from the body.

14. The method of claim 13 wherein
the body is opaque plastic; and
the body covers a portion of the optical element.

15. The method of claim 12 wherein the bulb portion and the socket portion have a shape defined by a standard.

16. The method of claim 12 wherein the body has a thermal conductivity of at least 1 Watt/meter-Kelvin.

17. The method of claim 12 wherein the electrically conducting substrate is a metal with a thermal conductivity of at least 100 Watt/meter-Kelvin.

18. The method of claim 12 wherein a portion of the body is coated with an electrically insulating coating.

19. The method of claim 12 wherein a portion of the electrically conducting substrate is coated with an electrically insulating coating.

20. The method of claim 12, further comprising electrically connecting a non-light-emitting electronic component to the LED.
